(19) United States
(12) Patent Application Publication
(10) Pub. No.: US 2008/0282712 A1
(43) Pub. Date: Nov. 20, 2008

(54) Method and apparatus for lowering the temperature of a mixture of water ice and CO2 snow

(76) Inventor: Paul R. Franklin, Jacksonville, FL (US)

Correspondence Address: JACOBSON HOLMAN PLLC, 400 SEVENTH STREET N.W., SUITE 600, WASHINGTON, DC, 20004, US

(21) Appl. No.: 11/437,660

(22) Filed: May 22, 2006

(51) Int. Cl. F25C 1/00; B60H 1/32; F25D 3/08; F25J 1/00

(52) U.S. Cl. 62/66; 62/606; 62/74; 62/239; 62/371

(57) ABSTRACT

A method and apparatus facilitate lowering the temperature of a cooling module positioned in heat exchange relation to a loaded container to be maintained at a low temperature. The module establishes convective air flow in heat exchange relation to the load without the use of forced air circulation. The module is self-contained and externally accessible to supply water and liquid CO₂ to the module interior. Expansion and change in state of the liquid CO₂ lowers the temperature of a water ice and CO₂ snow mixture in the module. By continuing inflow of CO₂ after terminating inflow of water, the mixture can be cooled from about −76° F. to about −117° F. Convective air flow in heat exchange relation to the module walls circulates cooling air, thereby eliminating any direct contact of products with the liquid CO₂ or CO₂ snow formed by the expanding refrigerant.

### BACKGROUND OF THE INVENTION

1. Field of the Invention

The present invention is directed to a method and apparatus for lowering the temperature of a mixture of water ice and CO₂ snow for cooling storage and transport containers and the like. The present invention controls the mixing of the water and liquid CO₂ in a cooling module in heat exchange relation to air circulating in a container having a load of products therein to maintain a desired temperature of the load during storage or transport of such products without the use of air circulating fans or other devices for assisting air circulation. The cooling module is associated with the interior of the container in a manner to establish convection air flow in heat exchange relation to the cooling module and the load of products in the container. The temperature of the water ice and CO₂ snow is controlled by maintaining the inflow of liquid CO₂ into the mixture beyond cessation of the inflow of water, so as to reduce the temperature of the water ice and CO₂ snow mixture from about −76° F. to about −117° F.

2. Description of the Related Art

The use of an expandable liquid refrigerant to cool or freeze products and the like during storage and transport is well known. Liquid carbon dioxide (CO₂) has been used successfully for many years in refrigeration by discharging pressurized liquid CO₂ through a nozzle or nozzles and expanding the CO₂ to reach a triple point condition where liquid, gaseous, and solid phases of CO₂ can coexist and flash to a mixture of CO₂ in a gaseous phase and particles of CO₂ snow. My below-listed prior U.S. patents relate to cooling of products in a load receiving container such as a truck body, railroad car, shipping container or the like which utilize liquid CO₂ as an expandable refrigerant that changes state:

4,376,511
4,381,649
4,462,423
4,502,293
4,640,460
5,092,133
5,154,064
5,259,199
5,295,368
5,398,522
5,505,055
5,775,111
6,109,058
6,182,458

While such prior systems have functioned successfully, some concern has arisen regarding the advisability of direct contact between CO₂ snow, liquid CO₂, and water and the contained products and with loading and unloading personnel, the truck operators, and other personnel that may come into contact with the products. Also, if water and liquid CO₂ are combined to vary the cooling temperature in a container, a residue, such as water, may be left on the products and on the interior of the container when the load is removed.

### SUMMARY OF THE INVENTION

In order to overcome the drawbacks of prior systems, the present invention utilizes a cooling module in heat exchange relation to a load receiving container. The cooling module is positioned in a manner to enable convective circulation of air in heat exchange relation to the exterior of the module and the products loaded into the container without the use of air fans or other air circulation devices, and without any direct contact of the coolant within the module with the load located in the container.

The cooling module is self-contained and provided with externally accessible pipes to supply pressurized liquid refrigerant and water with expansion and change in state of the refrigerant cooling the module and/or forming ice and CO₂ snow within the interior of the module. Convective air flow in heat exchange relation to the surface of the module circulates cooling air in heat exchange contact with the products, thereby eliminating any direct contact of the expanding refrigerant or water ice with the storage products, and without exposing personnel engaged in loading and unloading container loads or transporting such loads from contact with the refrigerant or water ice. However, when using convective air flow to maintain the products at a desired temperature, the air must be cooled to a temperature below that which is normally obtained by convective flow of air in heat exchange relation to a cooling module.

More specifically, the convective circulation of the air in accordance with the present invention is achieved because of the very cold −117° F. temperature at the cooling module which causes the air to fall to the floor. At the same time, hot air adjacent to the ceiling and above the products being cooled is drawn down for cooling, while the already cooled air is transported along the floor and underneath the products being cooled, away from the cooling module to the opposite end of the container. From there, the air rises to the ceiling and is drawn back along the ceiling, again above the products being cooled, to the cooling module, thus completing the convective air circulation.

It is therefore an object of the present invention to provide a cooling module in which the time period for the inflow of liquid CO₂ is extended for about 15-25 percent more than the time period for inflow of water. This extended CO₂ inflow unexpectedly results in a reduction in temperature of the water ice and CO₂ snow mixture in the cooling module from about −76° F. to about −117° F., thereby ensuring that air in heat exchange relation to the cooling module will maintain the products at a desired lowered temperature.

The load receiving container includes air circulation passageways around the exterior surfaces of the module and the interior surfaces of the container. Such passageways enable convective air circulation in heat exchange relation to the exterior surfaces of the module and in heat exchange relation to products within the container. This convective air circulation will maintain a desired low temperature within the interior of the container without any direct contact between the load in the container and the heat extracting coolant within the module, and without the use of air moving fans or other mechanical air circulating devices.

Another object of the present invention is to provide a cooling module for a container in which the interior of the module is accessible from a position exteriorly of the container. The access from the exterior facilitates the introduction of liquid water and liquid CO₂. The liquid water and expanding CO₂ initially produce a water ice block in the module and continuation of the liquid CO₂ flow produces CO₂ snow on top of the ice block. Thus, the cooling characteristics of the cooling module can be controlled.

Yet another object of the present invention is to provide a cooling module for a load receiving container in accordance with the preceding objects which will conform to conventional forms of manufacture, be of simple construction and easy to use so as to provide an apparatus that will be economically feasible, long lasting, and relatively trouble free in operation.

These together with other objects and advantages which will become subsequently apparent reside in the details of construction and operation as more fully hereinafter described and claimed, reference being had to the accompanying drawings forming a part hereof, wherein like numbers refer to like parts throughout. The drawings are intended to illustrate the invention and are not necessarily to scale.

### BRIEF DESCRIPTION OF THE DRAWINGS

FIG. 1 is a perspective view of a transport trailer having a cooling module positioned therein in accordance with the present invention.

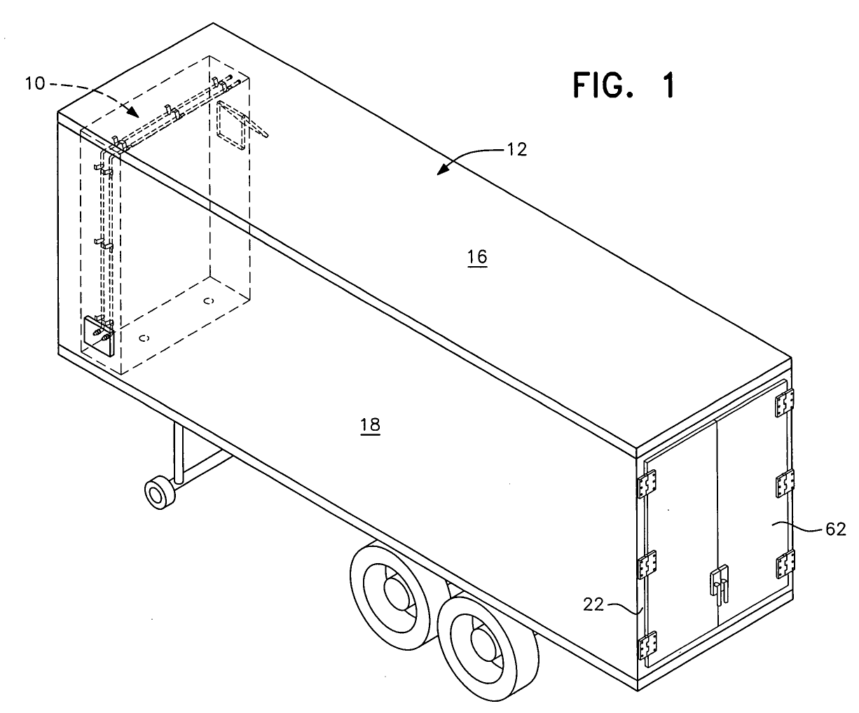

FIG. 2 is an enlarged view of the cooling module shown in FIG. 1, showing certain internal components in dashed lines.

FIG. 3 is a side view of the trailer and cooling module shown in FIG. 1, illustrating the load space and air flow passageways according to the present invention.

FIG. 4 is a vertical sectional view of the trailer taken along section line 4-4 of FIG. 3 illustrating details of the cooling module and the container.

FIG. 5 is a vertical sectional view of the cooling module taken along section line 5-5 of FIG. 2.

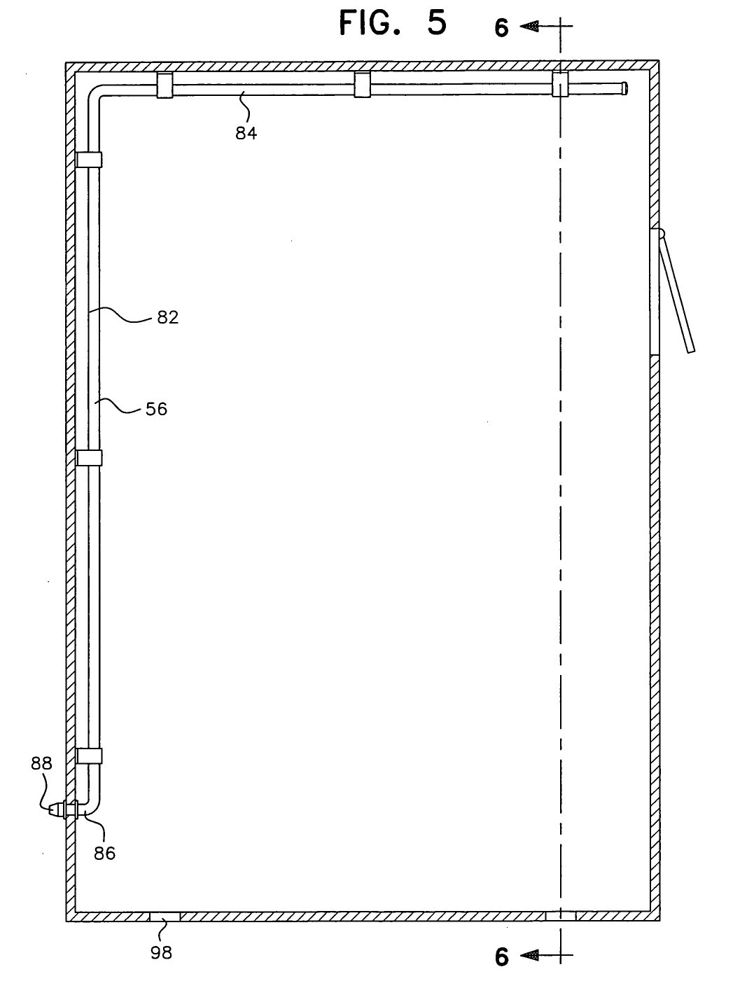

FIG. 6 is a vertical sectional view of the cooling module and components thereof taken along section line 6-6 of FIG. 5.

FIG. 7 is a vertical sectional view of the trailer and cooling module taken along section line 7-7 of FIG. 3.

### DETAILED DESCRIPTION OF THE PREFERRED EMBODIMENTS

Although only one preferred embodiment of the invention is explained in detail, it is to be understood that the invention is not limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents which operate in a similar manner to accomplish a similar purpose.

Referring specifically to the drawings, the present invention is incorporated in a standard insulated trailer 12 having wheels 13. The trailer 12 includes an insulated bottom wall 14, an insulated top wall or roof 16, insulated side walls 18, an insulated front end wall 20 and a rear end wall 22 usually formed by a pair of pivotal doors or, in some instances, a single pivotal door, a roll up door, or the like. The insulated walls While [symbol] connection with a transporting trailer, it will be understood by those skilled in the art that the present invention is applicable to any insulated load receiving container such as a trailer, truck body, railroad car, shipping container, or the like, and the use of “trailer” is intended to encompass all such storage and transporting structures for cooling products. Further, the specific dimensional characteristics of the trailer may vary but should comply with established requirements, regulations and rules when used in an over-the road truck body or trailer truck body and comply with standardized international requirements when used as a shipping container.

The floor of the trailer 12 includes a plurality of inverted channel-shaped metal deck members 39, which are anchored in any suitable manner and are typically included in any conventional refrigerated trailer. The deck members 39 cooperate with the bottom of a load positioned in a load space, generally designated by reference numeral 100, to form longitudinal bottom ducts or lower air passages 40. As is known by those skilled in the art, air enters the passageways 40 adjacent the front and moves longitudinally from the front of the trailer to the rear of the trailer under the load in the load space.

In accordance with the present invention, a cooling module, generally designated by reference number 10, is positioned on the trailer floor adjacent the front end of the trailer 12 and in heat exchange relation to the load space 100. The module 10 is preferably attached to the trailer front wall 20 by suitable brackets or the like. The positioning of the cooling module 10 adjacent to the front end wall 20 of the trailer 12 and in front of the load space 100 is preferred due to the insulation of the trailer walls and the distance from the trailer doors in the rear wall 22. Alternatively, the module 10 may be positioned externally of the trailer 12 and provided with insulated air passageways or ducts in convection air flow communication around the load space 100 as hereinafter described.

The load space 100 for receiving the load is defined by a front partition 32, a top partition 34, the floor channels 39, interior partitions 24 of side walls 18 and an open back 37. When installed in the front of the trailer 12, the module 10 is supported on channels 39 in spaced relation between the trailer front wall 20 and the load space front partition 32, above trailer bottom wall 14, below the trailer top wall 16 and along each of the trailer side walls 18, respectively. These spaced relationships provide a top passageway 26 between a top wall 23 of module 10 and the trailer top wall 16 and a vertical passageway 28 between the trailer front wall 20 and module front wall 19. A vertical passageway 30 is also formed between module back wall 25 and container front partition 32, vertical passageways 70 are formed on both ends 72 of module 10 spaced from the trailer side walls 18, and horizontal passageway 42 extends underneath module bottom wall 21. Preferably, the walls of module 10 are spaced approximately one inch away from their respective opposite walls inside the trailer.

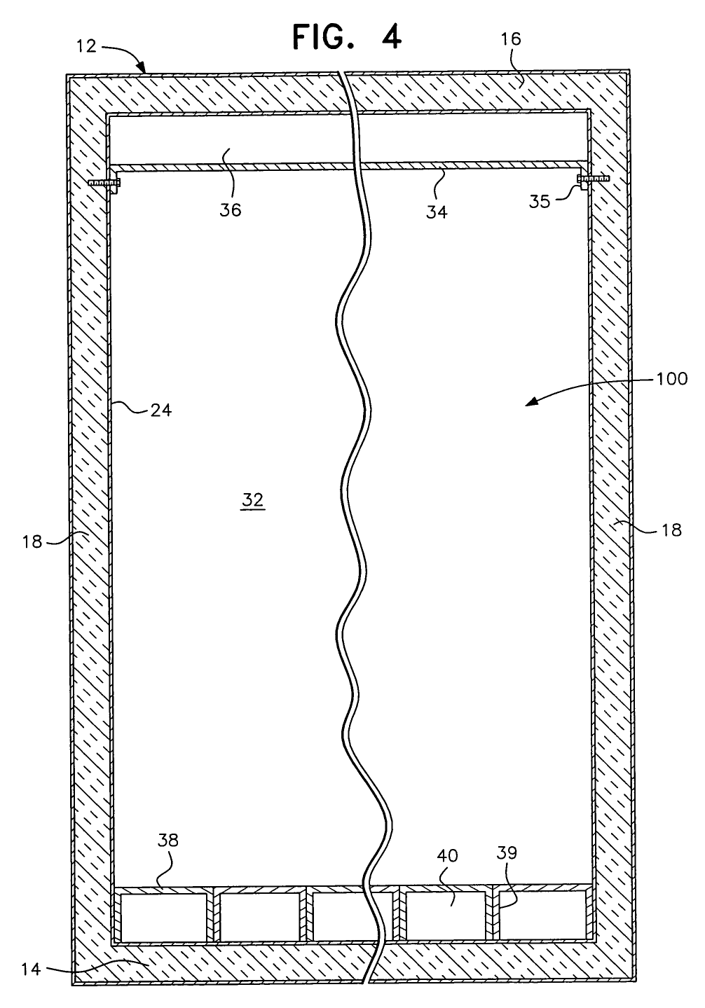

The load space front partition 32 has its upper end connected to a forward end of the load space horizontal top partition 34, which is spaced below the inside of trailer top wall 16 to form a longitudinal upper duct or passageway 36. The front partition 32 and top partition 34 extend completely across the width of the trailer 12, and top partition 34 extends along the full length of trailer 12, as illustrated in FIG. 4. The top partition 34 is preferably constructed of a sheet metal having a high heat conductivity, such as aluminum, or canvas, with downturned edge flanges 35 fastened to and supported by trailer side walls 18 (see FIG. 4). The front partition 32 is preferably constructed of sheet metal or plywood with flanges or attaching strips 43 fastened to and supported by the trailer side walls 18.

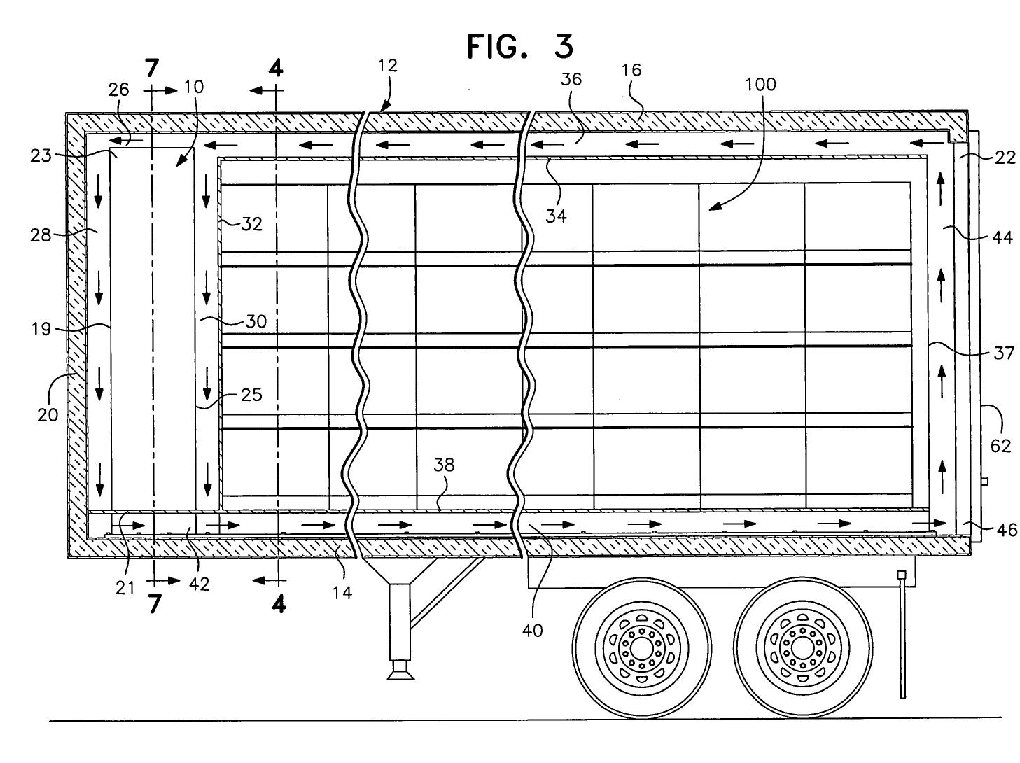

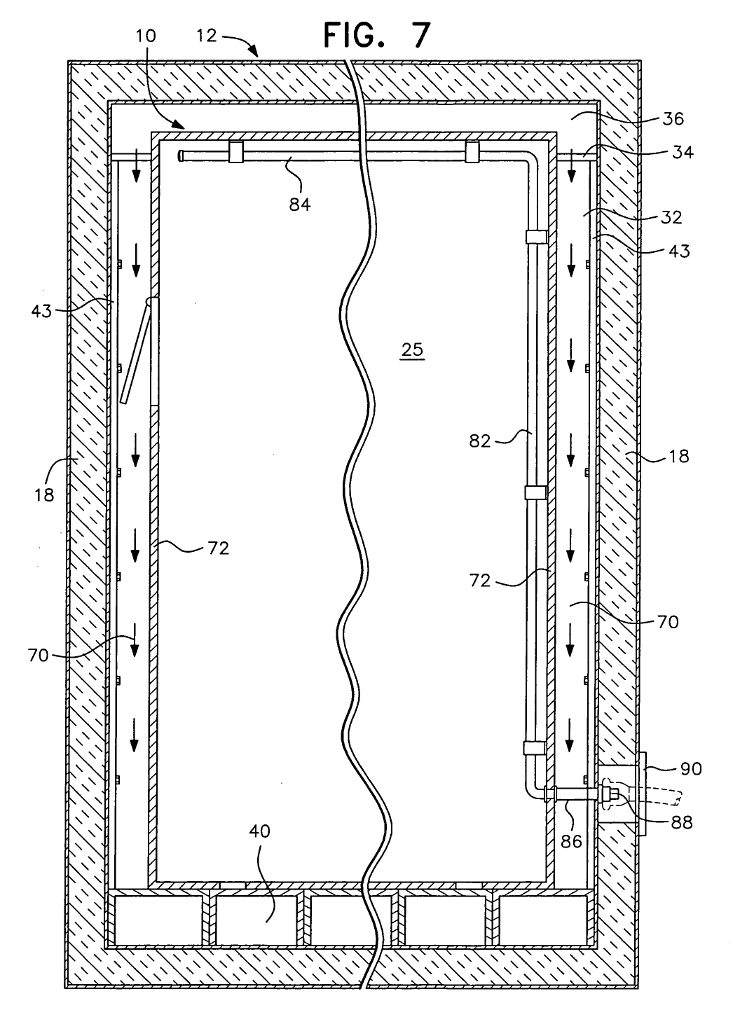

As illustrated in FIGS. 3, 4 and 7, the upper duct or passageway 36 communicates with the passageways 26, 28, 30 and 70, as well as the forward end portion 42 of the ducts 40 which extends in underlying relation to the module 10. Thus, warm air can move toward the front of the trailer 12 through upper passageway 36 with a substantially equal amount of air passing downwardly through the passageways 28, 30 and 70 into the lower passageway 42 and along ducts 40 toward the rear of the trailer 12. At the rear of the trailer 12, the air then moves upwardly along passageway 44 formed by vertical corrugation 46 usually provided on the inner surface of the door or doors forming end wall 22 for reentry into duct or passageway 36.

If the module 10 is to be mounted exteriorly of the trailer, an insulated housing encloses the module. Upper and lower insulated air passageways or ducts connect the insulated housing with air passageway 36 and ducts 40, respectively, inside the trailer. The convective air flow follows the same flow paths as shown in FIG. 3.

The top partition 34 which forms the upper duct or air passageway 36 and the passageway 36 extend completely across the trailer from one trailer side wall 18 to the other trailer side wall 18 to provide approximately a four inch high longitudinal passageway 36. The rear of the trailer 12 is provided with conventional access doors 62 which may be a single pivotal door, two pivotal doors, a roll up door, or any other conventional closure structure with the interior surface of the doors being provided with vertical corrugations 46 to provide vertical passageways between a load within the load space 100 and the rearward end wall 22 of the container.

In accordance with this invention, convective air circulation occurs as air which has been heated by passage in heat exchange relation to the products forming the load in load space 100 moves upwardly in space 44 and forwardly in passageway 36. The warm air in heat exchange contact with the module 10 is cooled and moves downwardly in the passageways 28, 30 and 70 and then rearwardly in the bottom air passageways 42 and 40 with heating and upward movement of the air occurring at the rear end of floor passageways 40 past the load. The heating of the air passing through the load and cooling of the air in contact with the cooling module 10 maintain the above described convective air flow.

The module 10 includes the necessary pipes 54 and 56 for selectively spraying variable amounts of water and liquid CO₂, respectively, downwardly from the top of the module 10. The pipes preferably include a vertical section 82 and a closed end horizontal section 84. The lower ends of the vertical sections turn with a short horizontal section 86 which extends outside the module and are fitted with externally accessible valves 88. The valves 88 for the respective water and liquid CO₂ are preferably mounted in the side wall 72 of the module 10 adjacent the front side wall access door 90 typically included in all conventional trailers.

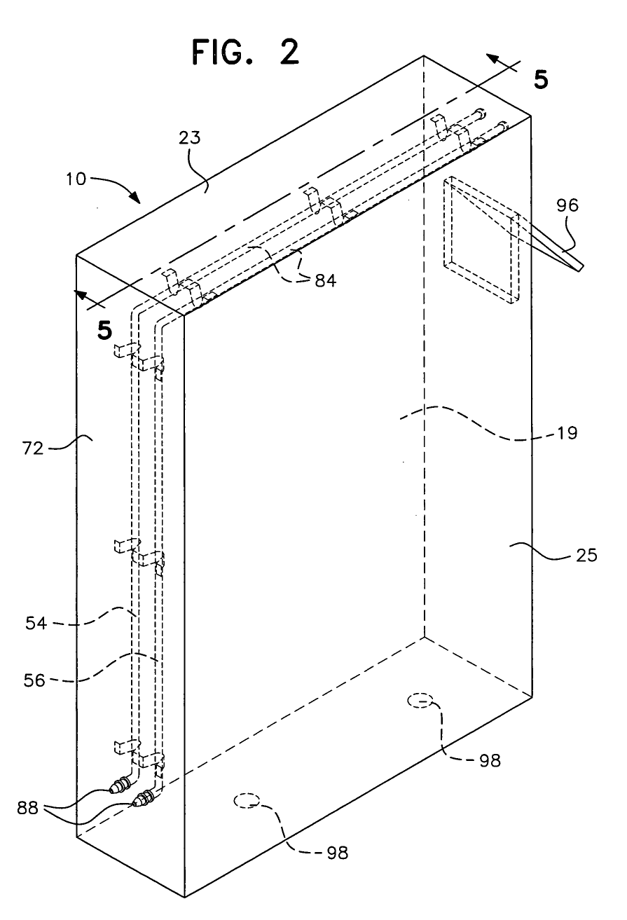

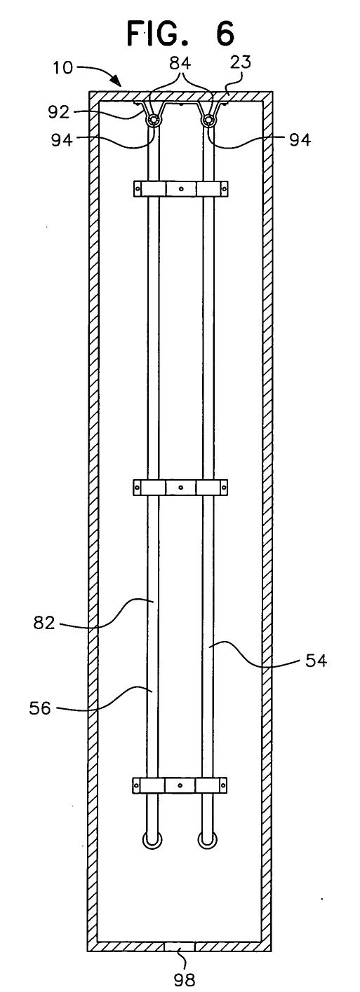

As shown in FIGS. 2 and 6, the horizontal sections 84 of pipes 54 and 56 are mounted side-by-side and suspended from the top 23 of module 10 by suitable brackets 92 or the like. The horizontal sections have downwardly facing holes 94 for spraying the water and CO₂ downwardly toward the bottom of module 10. The liquid CO₂ expands out of its holes 94 into CO₂ snow and CO₂ gas which mix with the exiting water to form water ice. The water ice and CO₂ snow form as a solid ice block and CO₂ snow inside the module 10 causing all of the wall surfaces of the module 10 to cool to a desired low temperature. The low temperature of the module walls will, in turn, maintain convective air circulation in order to maintain a load in load space 100 at a desired cool temperature.

A conventional pressure release flap valve 96 is located in a wall of the module 10, preferably in the side wall opposite the side wall having the water and liquid CO₂ inlets 88 therethrough. The valve 96 relieves any pressure build up inside the module 10 and allows the gases and vapors to escape to the atmosphere surrounding the module 10. The bottom or floor of the module 10 has holes 88, preferably two, which serve as outlet drains to allow water from melting ice to drain out of the module when no longer operating to cool. Water draining from the module 10 can drain from the trailer 12 through any of the floor drains typically provided in the trailer floor, usually adjacent each corner (not shown).

Liquid CO₂, when expanded, can produce a temperature as low as approximately −117° F. within the trailer 12. Frequently, ambient outside temperature reaches 100° F., resulting in a temperature differential of 217° F. Even with good insulation, a substantial heat loss can occur. By introducing water into the module along with liquid CO₂, the water ice and CO₂ snow will mix to form a slush at a temperature of about −46° F.

In the present invention, after the water ice and CO₂ snow mixture reaches a temperature of −76° F., water inflow is terminated. Unexpectedly, continuing inflow of liquid CO₂ for approximately 15-25 percent of the time period of inflow of water and CO₂ to reach a temperature of −76° F. results in a mixture of water ice and CO₂ snow at a substantially lower temperature. For example, if the time period to reach −76° F. is 1 hour, extending inflow of CO₂ for an additional 15-20 minutes lowers the temperature of the mixture to approximately −117° F., which enables module 10 to maintain the load in load space 100 at a desired low temperature of 0° F., or below, for at least several days.

A typical insulated trailer 12 for use in accordance with the present invention is approximately 50 feet long, 8 feet wide and 8 feet high. Module 10, in accordance with the present invention should have approximately a one inch clearance on all sides. Hence, the module would be almost 8 feet high, 8 feet wide and preferably about 2-3 feet thick.

A typical cooling cycle for a trailer 12 and module 10 having sizes as above described would be the following. Water and liquid CO₂ from external sources would be fed to their respective pipes 54 and 56 through valves 88, and out of their respective holes 94, simultaneously for a period of approximately 50 minutes. The mixture of water and liquid CO₂ should form a solid block of ice filling approximately 75% of the module height and reaching a temperature of approximately −76° F. The water to pipe 54 is then discontinued by shutting its respective valve 88, while liquid CO₂ continues to be fed to the module 10 for a period of approximately 10 or more minutes. During this extended inflow of CO₂, CO₂ snow is formed on top of the ice block up to about 2 inches below pipes 84. The temperature of the ice and CO₂ snow reduces to approximately −117° F. With this reduced temperature inside module 10, the module 10 should be able to maintain a temperature inside the load space 100 of 0° F., or below, for a period of several days.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A method of lowering the temperature of a mixture of water and CO₂, comprising the steps of:
introducing liquid water and expanding liquid CO₂ into a cooling module to form a water ice and CO₂ snow mixture at a first temperature;
terminating the introduction of liquid water into the module at a second temperature; and
continuing the introduction of expanding liquid CO₂ into the module to cool the water ice and CO₂ snow mixture to a third temperature lower than the second temperature, so as to lower the temperature of the cooling module.

2. The method as claimed in claim 1, wherein the step of introducing liquid water and liquid CO₂ comprises spraying a mixture of liquid water and liquid CO₂ into the module, and
the step of continuing the introduction of expanding liquid CO₂ comprises introducing liquid CO₂ for an additional time period of approximately 25 percent of a time period required to cool the introduced liquid water and expanding liquid CO₂to the second temperature.

3. The method as claimed in claim 1, wherein the first lowered temperature is approximately −46° F., the second lowered temperature is approximately −76° F., and the third lowered temperature is approximately −117° F.

4. A method of cooling a load body containing products, comprising the steps of:
lowering a temperature of a mixture of water and CO₂ by introducing liquid water and expanding liquid CO₂ into a cooling module to form a water ice and CO₂ snow mixture at a first temperature;
terminating the introduction of liquid water into the module at a second temperature; and
continuing the introduction of expanding liquid CO₂ into the module to cool the water ice and CO₂ snow mixture to a third temperature lower than the second temperature, so as to lower the temperature of the cooling module.

5. The method as claimed in claim 4, wherein the load body is cooled by positioning the cooling module in a heat exchange convective air flow in relation to the load body and products therein.

6. The method as claimed in claim 5, wherein the convective air flow isolates the water ice and CO₂ snow mixture from contact with the load body products and with personnel handling the products.

7. The method as claimed in claim 5, wherein the convective air flow extends longitudinally throughout the load body.

8. An apparatus for maintaining a reduced temperature in a load space, comprising:
a peripheral insulated wall enclosing the load space, the wall comprising vertically spaced substantially horizontal upper and lower surfaces, horizontally spaced substantially vertical end surfaces, and horizontally spaced substantially vertical side surfaces, the upper and lower surfaces, and the vertical side surfaces being connected to enclose the load space for receiving products during transport or storage;
a cooling module provided in heat exchange relation to the load space; and
air passageways provided along the surfaces of the load space and in heat exchange relation to the module for enabling convective air flow between the module and the load space.

9. The apparatus as claimed in claim 8, wherein the module includes a conduit for introducing liquid water and expanding liquid CO₂, and for forming a water ice and CO₂ snow mixture at a first temperature.

10. The apparatus as claimed in claim 9, wherein, after inflow of water has been terminated at a second temperature of the water ice and CO₂ snow mixture lower than the first temperature, the conduit is capable of continuing the introduction of expanding liquid CO₂ into the module to cool the water ice and CO₂ snow mixture to a third temperature lower than the second temperature, so as to lower the temperature of the module.

11. The apparatus as claimed in claim 8, wherein the lower and upper surfaces each comprise an inner wall and an outer wall, the inner and outer walls being spaced from each other to form air passageways, each of the inner walls having a length shorter than the outer walls so as to enable convective air flow through the load space.
